(19) United States
(12) Patent Application Publication
(10) Pub. No.: US 2012/0145005 A1
(43) Pub. Date: Jun. 14, 2012

(54) NEW PANEL FILTER AUGMENTATION TECHNIQUE FOR PARTICULATE CAPTURE GAINS

(75) Inventor: Robert Henry Devine, II, Lees Summit, MO (US)

(73) Assignee: General Electric Company, Schenectady, NY (US)

(21) Appl. No.: 12/964,781

(22) Filed: Dec. 10, 2010

(51) Int. Cl. B01D 46/10; B23P 11/00; B01D 53/22

(52) U.S. Cl. 96/4; 55/511; 29/428

(57) ABSTRACT

An accessory filter for enhancing the operation of a HVAC panel filter, the HVAC panel filter having a peripheral frame that is receivable in a filter mount of a forced air HVAC system. The accessory filter includes a filter sheet having planar dimensions matching the frame; and adhesive attached near the edges of the filter sheet operable to adhere the filter sheet to the frame. The filter sheet has a thickness substantially thinner than that of the HVAC panel filter. The filter sheet thickness allows the HVAC panel filter and the accessory filter to coextensively fit in the filter mount.

### BACKGROUND OF THE INVENTION

1. Field of the Invention

The present invention relates to heating, ventilating and air conditioning systems, and specifically relates to filters for such systems.

2. Discussion of the Prior Art

Forced air heating, ventilating and air conditioning (HVAC) systems typically include a filter for separating airborne particles from the system airflow. The most common filter is a panel filter. The panel filter is typically constructed of fibrous material supported by a peripheral frame, often formed of cardboard. The peripheral frame is received in a filter mount that holds the panel filter in the airflow of the forced air HVAC system. The panel filter then separates some portion of any airborne particles from the air as it flows through the filter.

Panel filters are available in a variety of standard sizes. In addition, panel filters are available with different filtering characteristics. In general, more expensive filters have the ability to separate smaller particles from the airflow. For example, a high efficiency particulate air (HEPA) filter will filter at least 99.97% of airborne particles 0.3 micrometers (μm) in diameter. It is not unusual for a HEPA filter to cost 3-5 times as much as less effective filters.

Referring to FIG. 1, an example of a prior art panel filter 1 includes a filter medium 2 with a frame 3 about the periphery of the filter medium 2. The planar dimensions of the filter 1 may be, for example, any of the commonly available sizes of such panel filters.

### BRIEF DESCRIPTION OF THE INVENTION

The following summary presents a simplified summary in order to provide a basic understanding of some aspects of the apparatus and/or methods discussed herein. This summary is not an extensive overview of the apparatus and/or methods discussed herein. It is not intended to identify key/critical elements or to delineate the scope of such apparatus and/or methods. Its sole purpose is to present some concepts in a simplified form as a prelude to the more detailed description that is presented later.

One aspect of the invention provides an accessory filter for enhancing the operation of a HVAC panel filter, the HVAC panel filter having a peripheral frame that is receivable in a filter mount of a forced. air HVAC system. The accessory filter includes a filter sheet having planar dimensions matching the frame; and adhesive attached near the edges of the filter sheet operable to adhere the filter sheet to the frame. The filter sheet has a thickness substantially thinner than that of the HVAC panel filter. The filter sheet thickness allows the HVAC panel filter and the accessory filter to coextensively fit in the filter mount.

Another aspect of the invention provides a method for enhancing the operation of a HVAC panel filter, the HVAC panel filter having a peripheral frame that is receivable in a filter mount of a forced air HVAC system. The method includes providing a filter sheet having planar dimensions matching the frame and a thickness substantially thinner than that of the HVAC panel filter, the filter sheet having adhesive attached near the edges of the filter sheet; adhering the filter sheet to the frame with the adhesive; and inserting the HVAC panel filter and the filter sheet into the filter mount in a coextensive fit.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a plan view of a prior art HVAC panel filter;

FIG. 2 is a plan view of an example of an accessory filter according to an aspect of the invention;

FIG. 3 is a schematic diagram of a forced air HVAC system using an accessory filter according to another aspect of the invention; and

FIG. 4 is a schematic diagram of a forced air HVAC system using an accessory filter according to still another aspect of the invention.

### DETAILED DESCRIPTION OF THE INVENTION

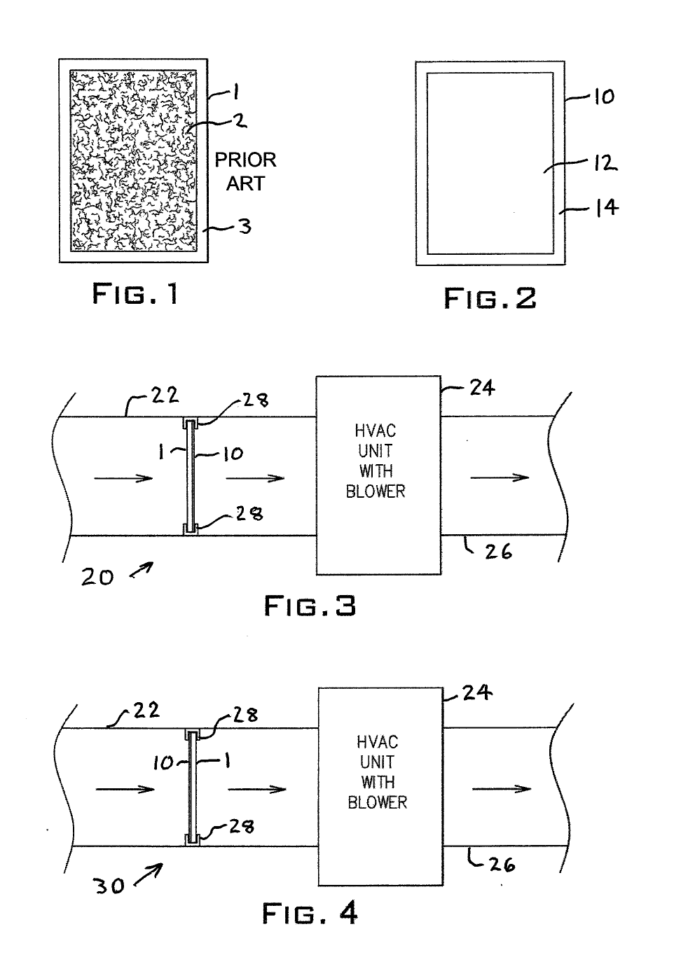

Referring to FIG. 2, an accessory filter 10 includes a filter sheet 12 with adhesive 14 attached near the edges of the filter sheet 12. The filter sheet 12 may be, for example, a membrane filter or other thin filtering medium. The adhesive 14 may be, for example, a pressure sensitive adhesive. The accessory filter 10 has planar dimensions that match those of the frame 3 of the panel filter 1 (see FIG. 1).

The adhesive 14 operates to adhere the accessory filter 10 to the frame 3 during use of the accessory filter 10. The adhesive 14 may be present on substantially less than the area indicated of the filter sheet 12, if still sufficient to attach the accessory filter 10 to the frame 3.

As used herein, the term forced air heating, ventilating and air conditioning (HVAC) system includes systems that may only heat, only air condition, only ventilate or may perform any combination of heating, cooling or ventilating.

Referring to FIG. 3, an example of a forced air HVAC system 20 includes an input duct 22, a HVAC. unit 24 that includes a blower for forcing the air and an exhaust duct 26. The input duct 22 includes a filter mount 28. For example, the filter mount 28 may be formed of channels as shown or other suitable structure for holding a panel filter in the path of airflow in the input duct 22.

The accessory filter 10 is adhered to the downstream side of the panel filter 1. The combination of the accessory filter 10 and the panel filter 1 are received in the filter mount 28.

The accessory filter 10 has a thickness substantially less than the panel filter 1. The thickness of the combination is thin enough to allow the combination of the accessory filter 10 and the panel filter 1 to coextensively fit in the filter mount 28. For example, the panel filter may have a thickness of 2-5 cm and the accessory filter a thickness of 0.5-2 mm. The inherent thinness of membrane filters make them useful as the filter sheet 12. Of course, it is to be appreciated that such thicknesses are merely examples and that different and/or additional thickness values are possible.

Membrane filters are essentially relatively thin membranes covered with perforations sized to permit particles below a desired size to pass through.

In operation, air flows in the input duct 22 through the combination of the panel filter 1 and the accessory filter 10, into the HVAC unit 24 and out through the output duct 26. In some HVAC units, the input duct 22 and/or the output duct 26 may be, for example, of essentially zero lengths. For example, the combination of the panel filter 1 and the accessory filter 10 may be located within the housing of the HVAC unit and the air output may be no more than a downstream opening in the HVAC unit.

As an example, the accessory filter 10 may be chosen to meet the HEPA standard (filters at least 99.97% of airborne particles 0.3 micrometers (μm) in diameter), while the panel filter 1 would be chosen to be a substantially less effective filter. The panel filter 1 will primarily capture larger particles (greater than 0.3 μm) and the accessory filter 10 will separate remaining particles down to the 0.3 μm size.

The accessory filter 10, for example, may be used to enhance the panel filter 1 by removing additional airstream particles beyond what the panel filter alone is capable of removing. In many cases, it may be possible to use an accessory filter—panel filter combination that has a total cost that is less expensive than just a panel filter that provides the same performance. For example, the cost of the combination of a low performance panel filter and a membrane filter can be substantially less than a HEPA panel filter, and still provide similar performance.

Referring to FIG. 4, another example of a forced air HVAC system 30 is similar to the system of FIG. 3 except that the positions of the panel filter 1 and the accessory filter 10 are reversed. In this case, the accessory filter 10 is adhered to the upstream side of the panel filter 1.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. An accessory filter for enhancing the operation of a HVAC panel filter, the HVAC panel filter having a peripheral frame that is receivable in a filler mount of a forced air HVAC system, the accessory filter including:
a filter sheet having planar dimensions matching the frame; and
adhesive attached near the edges of the filter sheet operable to adhere the filter sheet to the frame, wherein the filter sheet has a thickness substantially thinner than that of the HVAC panel filter, the filter sheet thickness allowing the HVAC panel filter and the accessory filter to coextensively fit in the filter mount.

2. An accessory filter according to claim 1, wherein the accessory filter is attachable to a downstream side of the HVAC panel filter.

3. An accessory filter according to claim 1, wherein the accessory filter is attachable to an upstream side of the HVAC panel filter.

4. An accessory filter according to claim 1, wherein the filter sheet is a membrane filter.

5. An accessory filter according to claim 1, wherein the accessory filter is operable to separate smaller airborne particles than the HVAC panel filter.

6. A method for enhancing the operation of a HVAC panel filter, the HVAC panel filter having a peripheral frame that is receivable in a filter mount of a forced air HVAC system, the method including:
providing a filter sheet having planar dimensions matching the frame and a thickness substantially thinner than that of the HVAC panel filter, the filter sheet having adhesive attached near the edges of the filter sheet;
adhering the filter sheet to the frame with the adhesive; and
inserting the HVAC panel filter and the filter sheet into the filter mount in a coextensive fit.

7. A method according to claim 6, wherein the filter sheet is adhered to a downstream side of the HVAC panel filter.

8. A method according to claim 6, wherein the filter sheet is adhered to an upstream side of the HVAC panel filter.

9. A method according to claim 6, wherein the filter sheet is a membrane filter.

10. A method according to claim 6, wherein the filter sheet is operable to separate smaller airborne particles than the HVAC panel filter.
